(19) United States
(12) Patent Application Publication
(10) Pub. No.: US 2014/0130162 A1
(43) Pub. Date: May 8, 2014

(54) PHISHING PREVENTING SYSTEM AND OPERATING METHOD THEREOF

(71) Applicant: Electronics and Telecommunications Research Institute, Daejeon (KR)

(72) Inventors: Seung Hyun KIM, Daejeon (KR); Seung Hun Jim, Daejeon (KR); Jin Man Cho, Daejeon (KR); Young Seob Cho, Daejeon (KR); Sang Rae Cho, Daejeon (KR); Jong Hyouk Noh, Daejeon (KR); Soo Hyung Kim, Daejeon (KR); Seok Hyun Kim, Jeollanam-do (KR); Dae Seon Choi, Daejeon (KR)

(21) Appl. No.: 13/946,803

(22) Filed: Jul. 19, 2013

(30) Foreign Application Priority Data
Nov. 2, 2012 (KR) 10-2012-0123734

(51) Int. Cl. H04L 29/06

(52) U.S. Cl. CPC H04L 63/1408
USPC 726/23

(57) ABSTRACT

A phishing preventing system includes: a user computer outputting, at the time of accessing a predetermined website, a request signal for verifying whether the website is authenticated; a web server generating link information on the website at the time of inputting user information on the user computer and the request signal at the time of accessing the website and outputting the link information to the user computer; and a user terminal verifying whether the website is authenticated by comparing the link information with set normal authentication information by receiving the user information corresponding to the link information from the web server at the time of inputting terminal link information corresponding to the link information from the user computer.

### CROSS-REFERENCE TO RELATED APPLICATIONS

This application claims priority to and the benefit of Korean Patent Application No. 10-2012-0123734 filed in the Korean Intellectual Property Office on Nov. 2, 2012, the entire contents of which are incorporated herein by reference.

### TECHNICAL FIELD

Exemplary embodiments of the present invention relate to a phishing preventing system and an operating method thereof, and more particularly, to a phishing preventing system and an operating method thereof that prevent access by a phishing site by verifying whether a predetermined website accessed by a user computer is authenticated, in a user terminal and easily prevent damages caused by extortion or stealing of a user's ID/PW.

### BACKGROUND ART

Phishing is an attack technology that extorts personal information such as a user's ID/PW, or the like by disguising itself as a normal website. Various types of phishing preventing technologies such as two-factor authentication, a security cookie, a browser toolbar, specific hardware/software interworking, and a server-based approach have been introduced, but do not normally cope with a recent active phishing attack.

A user could comparatively easily recognize an existing phishing site having a static structure as an abnormal website, but since an active phishing site is a system that simplifies/modulates, and forwards a webpage between the normal website and the user, it is difficult for the user to recognize the active phishing site. Since a security element of the webpage is appropriately removed and transferred to the user, security techniques, which are commonly used in the existing phishing site, can be incapacitated.

Some techniques can cope with active phishing, but there is an inconvenience that installation of hardware/software is requested each time and there is a problem of mobility in which some techniques are usable only in a specific PC. In particular, since an authentication technology such as a one time password (OTP)/SMS authentication number is effective only for a limited time, it is evaluated that the authentication technology is safe even though the authentication technology is exposed, but since the active phishing site can misuse the authentication technology within a limited time, the phishing site has become a serious problem.

In recent years, a study for preventing active phishing has been in progress.

### SUMMARY OF THE INVENTION

The present invention has been made in an effort to provide a phishing preventing system and an operating method thereof that prevent access by a phishing site by verifying whether a predetermined website accessed by a user computer is authenticated, in a user terminal and easily prevents damages caused by extortion or stealing of a user's ID/PW.

An exemplary embodiment of the present invention provides a phishing preventing system, including: a user computer outputting, at the time of accessing a predetermined website, a request signal for verifying whether the website is authenticated; a web server generating link information on the website at the time of inputting user information on the user computer and the request signal at the time of accessing the website and outputting the link information to the user computer; and a user terminal verifying whether the website is authenticated by comparing the terminal link information with set normal authentication information by receiving the user information corresponding to the link information from the web server at the time of inputting terminal link information corresponding to the link information from the user computer.

Another exemplary embodiment of the present invention provides an operating method of a phishing preventing system, including: transmitting, by a user computer, at the time of accessing a predetermined website, a request signal for verifying whether the website is authenticated, to a web server; generating, by the web server, at the time of inputting the request signal, link information on the website and transmitting the generated link information to the user computer, generating user information on the user computer which access the website, and mapping the link information and the user information; determining, by the user computer, whether to receive link information corresponding to the request signal from the web server; converting, by the user computer, the link information into terminal link information and transmitting the terminal link information to the user terminal, at the time of receiving the link information; transmitting, by the user terminal, the terminal link information to the web server and receiving the user information mapped to the link information from the web server; and comparing, by the user terminal, the user information and set normal authentication information and verifying whether the website is authenticated.

According to the exemplary embodiments of the present invention, the phishing preventing system and the operating method thereof can verify whether a predetermined website included in a web server accessed by a user computer through a user terminal is a normal site or a phishing site in order to block an active phishing site and reduce a burden of installation of separate hardware and software.

The phishing preventing system and the operating method thereof according to the exemplary embodiment of the present invention can verify whether the website is authenticated through the user terminal to increase mobility.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a system diagram illustrating a phishing preventing system according to an exemplary embodiment.

FIG. 2 is a control block diagram illustrating a control configuration of the phishing preventing system according to the exemplary embodiment of the present invention.

FIG. 3 is a flowchart illustrating an operating method of a phishing preventing system according to another exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Advantages and features of the present invention and methods for achieving them will be made clear from exemplary embodiments described below in detail with reference to the accompanying drawings. However, the present invention is not limited to exemplary embodiments described herein and will be implemented in various forms. The exemplary embodiments are provided by way of example only so that a person of ordinary skill in the art can fully understand the disclosures of the present invention and the scope of the present invention. Therefore, the present invention will be defined only by the scope of the appended claims. Like reference numerals designate like components throughout the specification.

When it is determined that the detailed description of the known art related to the present invention may obscure the gist of the present invention, the detailed description thereof will be omitted. In addition, terms to be described below as terms defined by considering functions in the exemplary embodiment of the present invention may depend on a user, an intention or a practice of a user or an operator. Therefore, the definition should be made based on contents throughout the specification.

Combinations of respective blocks of the accompanying block diagram and respective steps of a flowchart may be executed by computer program instructions. Since the computer program instructions can be installed in a processor of a general computer, a special computer, or other programmable data processing equipment, the instructions executed through the processor of the computer or other programmable data processing equipment generates means that executes functions described in the respective blocks of the accompanying block diagram and the respective steps of the flowchart. Since the computer program instructions may be stored in a computer usable or readable memory which can aim at the computer or other programmable data processing equipment in order to implement the functions in a specific method, the instructions stored in the computer usable or readable memory can produce a manufacturing item including instruction means that performs the functions described in each block of the block diagram or each step of the flowchart. Since the computer program instructions may be installed in the computer or other programmable data processing equipment, the instructions that generate a process executed by the computer through execution of a series of operating steps in the computer or other programmable data processing equipment and carry out the computer or other programmable data processing equipment can provide steps for executing the functions described in each block of the block diagram and each step of the flowchart.

Each block or each step may represent a part of a module, a segment, or a code including one or more executable instructions for executing a specific logical function(s). In several substituted exemplary embodiments, it is noted that the functions described in the blocks or steps may also occur out of order. For example, two blocks or steps illustrated successively may be executed substantially at the same time or the blocks or steps may be occasionally executed in a reverse order depending on corresponding functions.

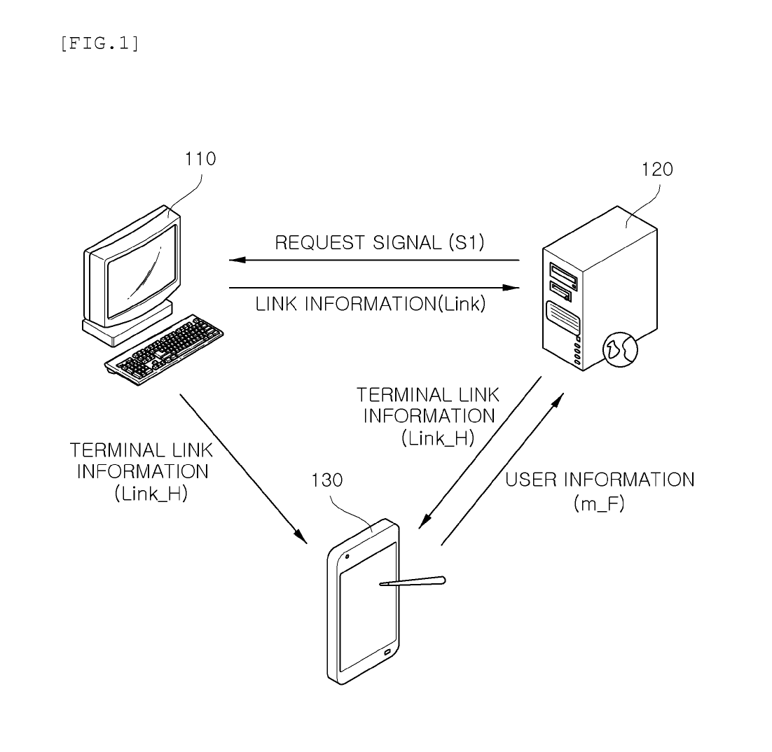

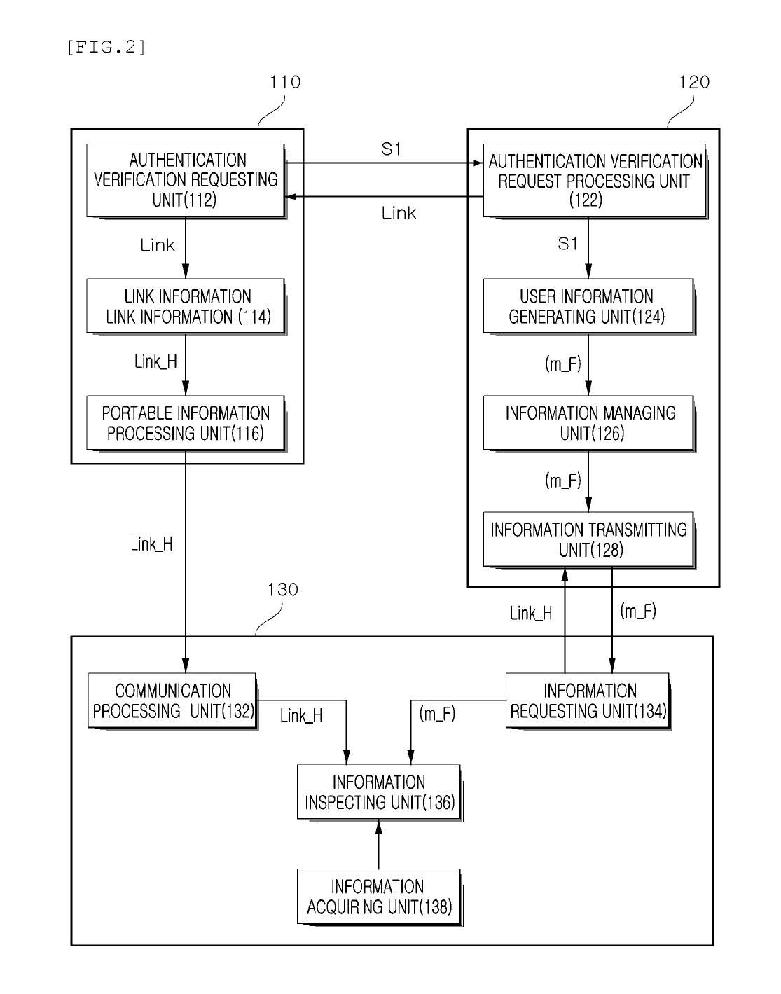

FIG. 1 is a system diagram illustrating a phishing preventing system according to an exemplary embodiment. FIG. 2 is a control block diagram illustrating a control configuration of the phishing preventing system according to the exemplary embodiment of the present invention.

Referring to FIGS. 1 and 2, the phishing preventing system may include, at the time of accessing a predetermined website, a user computer 110 outputting a request signal s1 for verifying whether the website is authenticated, a web server 120 generating link information Link on the website at the time of inputting user information m_F on the user computer 110 and the request signal s1 at the time of accessing the website and outputting the link information Link to the user computer 110, and a user terminal 130 verifying whether the website is authenticated by comparing the user information m_F with set normal authentication information by receiving the user information m_F corresponding to the link information Link from the web server 120 at the time of inputting terminal link information Link_H corresponding to the link information Link from the user computer 110.

In the exemplary embodiment, the user computer 110 may include a web browser or may be described as the web browser, and the present invention is not limited thereto.

In the exemplary embodiment, the web server 120 may be a server that provides the website or may be described as the website, and the present invention is not limited thereto.

The user computer 110 includes an application program or a web browser that accesses a predetermined website included in the web server 120, and the web browser is described to be the same as the user computer 110.

The user computer 110 includes an authentication verification requesting unit 112 transmitting the request signal s1 to the web server 120, a link information processing unit 114 receiving the link information Link from the web server 120 and converting the link information Link into the terminal link information Link_H to be recognized by the user terminal 130, and a portable information processing unit 116 transmitting the terminal link information Link_H to the user terminal 130.

The authentication verification requesting unit 112 generates a request signal s1 for determining whether the website is a normal site or a phishing site and transmits the generated request signal s1 to the web server 120.

The link information processing unit 114 determines the website as the phishing site at the time of not receiving the link information Link from the web server 120 to store the determined website in a set phishing site list or determines the website as a normal site at the time of receiving the link information Link from the web server 120 to store the determined website in a set normal site list.

The link information Link may include an endpoint URL and a session ID of the website and the present invention is not limited thereto.

The link information processing unit 114 may generate the terminal ink information Link_H so as for the user terminal 130 to recognize the link information Link at the time of receiving the link information Link.

The terminal link information Link_H may be, for example, information acquired by converting text information into a format such as a QR code, sound, NFC, Bluetooth, infrared communication, or the like.

In this case, the portable information processing unit 116 transmits the terminal link information Link_H to the user terminal 130.

In the exemplary embodiment, the authentication verification requesting unit 112, the link information processing unit 114, and the portable information processing unit 116 may be mounted on the user computer 110 as a module format or installed by being provided from the website through downloading at the time of accessing the website, and the present invention is not limited thereto.

When the request signal s1 is input, the web server 120 includes an authentication verification request processing unit 122 transmitting the link information Link on the website to the user computer 110, a user information generating unit 124 collecting and generating the user information m_F on the user computer 110 that accesses the website, an information managing unit 126 mapping the link information Link and the user information m_F and storing the mapped information, and an information transmitting unit 128 transmitting the user information m_F corresponding or mapped to the link information Link at the time when the user terminal 130 is accessed.

The authentication verification request processing unit 122 receives the request signal s1 to verify that the website is normal from the user computer 110 and transmits the link information Link to the user computer 110.

The user information generating unit 124 may generate the user information m_F by collecting information to uniquely identify the user computer 110 or the web browser.

In this case, the user information m_F may include at least one of an IP and a browser type of the user computer 110 or the web browser, and may include other types of information to identify the user computer 110 and the web browser, and the present invention is not limited thereto.

The information managing unit 126 maps and stores the link information Link and the user information m_F to be provided to the user computer 110 or the web browser to correspond to each other.

The information transmitting unit 128 transmits to the user terminal 130 the user information m_F mapped to the link information Link at the time of receiving the terminal link information Link_H into which the link information Link is converted, from the user terminal 130.

The user terminal 130 includes a communication processing unit 132 receiving the terminal link information Link_H from the user computer 110 or the web browser, an information requesting unit 134 requesting and receiving user information m_K corresponding to the link information Link by accessing the website corresponding to the terminal link information Link_H, an information inspecting unit 136 determining whether the website is normal based on the user information m_K and the normal authentication information, and an information acquiring unit 138 setting the normal authentication information.

The communication processing unit 132 receives the terminal link information Link_H from the user computer 110 or the web browser.

That is, the communication processing unit 132 may receive the terminal link information Link_H by recognizing the QR code displayed on the user computer 110 or the web browser by driving a code application when the terminal link information Link_H is the QR code, and the present invention is not limited thereto.

The information requesting unit 134 requests and receives the user information m_F mapped to the link information Link by approaching the endpoint URL of the website corresponding to the terminal link information Link_H.

The information acquiring unit 138 acquires information to verify whether the website is authenticated, that is, the normal authentication information.

The normal authentication information may include a normal site list associated with a previously accessed website, a phishing site list, and GPS information on a present position, and the present invention is not limited thereto.

The information inspecting unit 136 determines whether the user computer 110 or the web browser accesses the normal website by comparing the user information m_F and the normal authentication information with each other.

When the website is the normal site, the information inspecting unit 136 stores the website in the set normal site list and when the website is the phishing site, the information inspecting unit 136 stores the website in the set phishing site list.

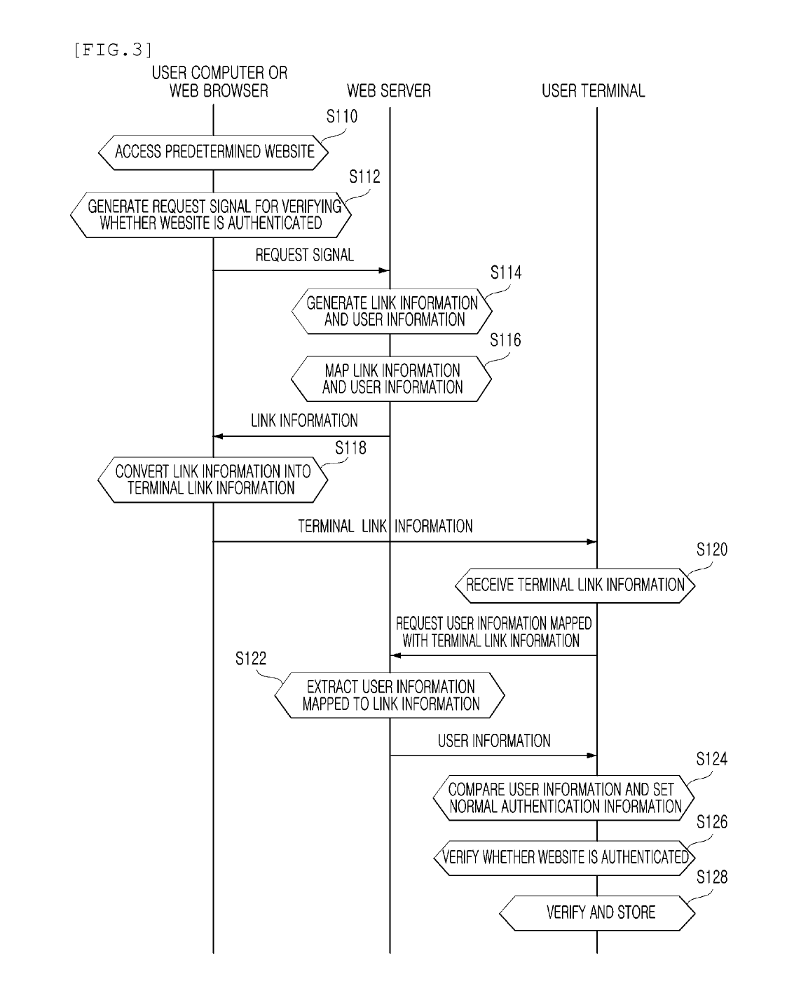

FIG. 3 is a flowchart illustrating an operating method of a phishing preventing system according to another exemplary embodiment.

In FIG. 3, reference numerals for components illustrated in FIGS. 1 and 2 may be used and will be schematically described.

Referring to FIG. 3, in the phishing preventing system, the user computer 110 or the web browser accesses a predetermined website included in the web server 120 (S110), and generates the request signal s1 for verifying whether the website is authenticated and transmits the generated request signal s1 to the web server 120 (S112).

That is, the user computer 110 or the web browser generates the request signal s1 for verifying whether the website is authenticated when accessing the predetermined website.

The request signal s1 is a signal for requesting the information for verifying whether the website is authenticated and the link information Link provided to the user terminal 130.

The web server 120 generates the link information Link and the user information m_F based on the request signal s1 transmitted from the user computer 110 or the web browser (S114), maps and stores the generated link information Link and user information m_F, and transmits the link information Link to the user computer 110 and the web browser (S116).

That is, the web server 120 generates and maps the link information on the website based on the transmitted request signal s1 and the user information m_F on the user computer 110 or the web browser.

The user computer 110 or the web browser converts the transmitted link information Link into the terminal link information Link_H s as for the user terminal 130 to recognize the transmitted link information Link and transmits the terminal link information Link_H to the user terminal 130 (S118).

That is, the user computer 110 or the web browser converts the link information Link into the terminal link information Link_H and transmits the terminal link information Link_H to the user terminal 130, at the time of receiving the link information Link.

In this case, the user computer 110 or the web browser may determine the website as the phishing site to store the website in the phishing site list, at the time of not receiving the link information Link, and the present invention is not limited thereto.

The user terminal 130 requests the user information m_F mapped to the terminal link information Link_H to the web server 120, at the time of receiving the terminal link information Link_H (S120).

The web server 120 extracts the user information m_F mapped or corresponding to the transmitted terminal link information Link_H and transmits the extracted user information m_F to the user terminal 130 (S122).

That is, the web server 120 transmits user information m_F corresponding to the link information Link_H not converted into the terminal link information Link_H to the user terminal 130 when the terminal link information Link_H is transmitted.

The user terminal 130 compares the transmitted user information m_F and the set normal authentication information with each other (S124) in order to verify whether the accessed website is the normal site or the phishing site (S126) and store the verification result (S128).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A phishing preventing system, comprising:
a user computer outputting, at the time of accessing a predetermined website, a request signal for verifying whether the website is authenticated;
a web server generating link information on the website at the time of inputting user information on the user computer and the request signal at the time of accessing the website and outputting the link information to the user computer; and
a user terminal verifying whether the website is authenticated by comparing the link information with set normal authentication information by receiving the user information corresponding to the link information from the web server at the time of inputting terminal link information corresponding to the link information from the user computer.

2. The system of claim 1, wherein
the user computer includes a web browser that accesses the website, and
the web browser includes:
an authentication verification requesting unit transmitting the request signal to the web server, and
a link information processing unit receiving the link information from the web server and converting the link information into the terminal link information to be recognized by the user terminal.

3. The system of claim 2, wherein the web browser includes a portable information processing unit transmitting the terminal link information to the user terminal.

4. The system of claim 2, wherein the authentication verification requesting unit generates the request signal for determining whether the website is a normal site or a phishing site.

5. The system of claim 2, wherein the link information processing unit determines the website as the phishing site at the time of not receiving the link information to store the website in a set phishing site list.

6. The system of claim 2, wherein the link information processing unit determines the website as the normal site at the time of receiving the link information to store the website in a set normal site list.

7. The system of claim 1, wherein
the web server includes:
an authentication verification request processing unit transmitting the link information on the website to the user computer, when the request signal is input,
a user information generating unit collecting and generating the user information on the user computer that accesses the website, and
an information managing unit mapping the link information and the user information and storing the mapped information.

8. The system of claim 7, wherein the web server includes an information transmitting unit transmitting the user information corresponding to the link information at the time when the user terminal is accessed.

9. The system of claim 1, wherein
the user terminal includes:
a communication processing unit receiving the terminal link information,
an information requesting unit requesting and receiving the user information corresponding to the link information by accessing the website corresponding to the terminal link information, and
an information inspecting unit determining whether the website is normal based on the user information and the normal authentication information.

10. The system of claim 9, wherein
the user terminal includes an information acquiring unit setting the normal authentication information, and
the normal authentication information includes a normal site list associated with a previously accessed website, a phishing site list, and GPS information on a present position.

11. An operating method of a phishing preventing system, comprising:
transmitting, by a user computer, at the time of accessing a predetermined website, a request signal for verifying whether the website is authenticated, to a web server;
generating, by a(the?) web server, at the time of inputting the request signal, link information on the website and transmitting the generated link information to the user computer and generating user information on the user computer which access the website and mapping the link information and the user information;
determining, by the user computer, whether to receive link information corresponding to the request signal from the web server;
converting, by the user computer, the link information into terminal link information and transmitting the terminal link information to the user terminal, at the time of receiving the link information;
transmitting, by the user terminal, the terminal link information to the web server and receiving the user information mapped to the link information from the web server; and
comparing, by the user terminal, the user information and set normal authentication information and verifying whether the website is authenticated.

12. The method of claim 11, wherein the request signal is a signal for determining whether the website is a normal site or a phishing site.

13. The method of claim 11, wherein in the determining, the website is determined as the phishing site at the time of not receiving the link information to be stored in a set phishing site list.

14. The method of claim 11, wherein in the determining, the website is determined as the normal site at the time of receiving the link information to be stored in a set normal site list.

15. The method of claim 11, wherein the user information includes at least one of an IP and a web browser type of the user computer.

16. The method of claim 11, wherein the terminal link information is the link information converted into a format to be verified by the user terminal.

17. The method of claim 11, wherein the terminal link information is transmitted by at least one communication system of an SMS, a QR code, sound, NFC, Bluetooth, and an RF channel.

18. The method of claim 11, wherein the normal authentication information includes a normal site list associated with a previously accessed website, a phishing site list, and GPS information on a present position.
